(19) United States
(12) Patent Application Publication
(10) Pub. No.: US 2011/0253685 A1
(43) Pub. Date: Oct. 20, 2011

(54) LASER PROCESSING SYSTEM WITH VARIABLE BEAM SPOT SIZE

(75) Inventors: Wei-Yung Hsu, San Jose, CA (US); Antoine P. Manens, Sunnyvale, CA (US)

(73) Assignee: Applied Materials, Inc., Santa Clara, CA (US)

(21) Appl. No.: 13/076,422

(22) Filed: Mar. 30, 2011

Related U.S. Application Data
(60) Provisional application No. 61/319,186, filed on Mar. 30, 2010.

(51) Int. Cl. B23K 26/00

(52) U.S. Cl. 219/121.67

(57) ABSTRACT

Systems for scribing a workpiece incorporate a motorized beam expander to change a laser beam spot size incident on a workpiece. A system includes a frame, a laser coupled with the frame and generating an output to remove material from at least a portion of a workpiece, a beam expander positioned along a path of the laser output and having a motorized mechanism operable to vary a beam expansion ratio applied to the laser output, and at least one scanning device coupled with the frame and operable to control a position of the laser output, after expansion, on the workpiece. The motorized beam expander can be used to selectively vary the width of a laser beam supplied to a scanning device so as to selectively vary the size of the laser beam incident on the workpiece. Alternatively, a variable aperture can be used instead of a beam expander.

### CROSS-REFERENCES TO RELATED APPLICATIONS

This application claims the benefit of U.S. Prov. Patent Application No. 61/319,186 filed Mar. 30, 2010, and titled “LASER PROCESSING SYSTEM WITH VARIABLE BEAM SPOT SIZE,” which is incorporated in its entirety by reference for all purposes. The present application is related to U.S. patent application Ser. No. 12/939,137, entitled “MULTI-WAVELENGTH LASER-SCRIBING TOOL,” filed on Nov. 3, 2001, the full disclosure of which is incorporated herein by reference.

### BACKGROUND

Various embodiments described herein relate generally to systems for scribing or patterning a workpiece, and more particularly to systems for laser scribing a workpiece with a selectable size for a laser beam incident on the workpiece. Such systems can be particularly effective for laser-scribing glass substrates having at least one layer used to form thin-film solar cells.

Current methods for forming thin-film solar cells involve depositing or otherwise forming a plurality of layers on a substrate, such as a glass, metal or polymer substrate suitable to form one or more p-n junctions. An example thin-film solar cell includes a glass substrate having a transparent-conductive-oxide (TCO) layer, a plurality of doped and undoped silicon layers, and a metal back layer. Examples of materials that can be used to form solar cells, along with methods and apparatus for forming the cells, are described, for example, in U.S. Pat. No. 7,582,515, entitled “MULTI-JUNCTION SOLAR CELLS AND METHODS AND APPARATUSES FOR FORMING THE SAME,” the entire disclosure of which is hereby incorporated herein by reference.

When a panel is formed from a large substrate, a series of laser-scribed lines can be used within each layer to delineate individual cells. FIG. 1 diagrammatically illustrates an example solar-cell assembly 10 that includes scribed lines, for example, laser-scribed lines. The solar-cell assembly 10 can be fabricated by depositing a number of layers on a glass substrate 12 and scribing a number of lines within the layers. The fabrication process begins with the deposition of a TCO layer 14 on the glass substrate 12. A first set of lines 16 (“P1” interconnect lines and “P1” isolation lines) are then scribed within the TCO layer 14. A plurality of doped and undoped amorphous silicon (a-Si) layers 18 are then deposited on the TCO layer 14 and within the first set of lines 16. A second set of lines 20 (“P2” interconnect lines) are then scribed within the silicon layers 18. A metal layer 22 is then deposited on the silicon layers 18 and within the second set of lines 20. A third set of lines 24 (“P3” interconnect lines and “P3” isolation lines) are then scribed as illustrated.

The optimal beam size incident on the workpiece depends on the use of the resulting thin-film solar cell. For example, a small spot size can be used for interconnect line scribing in order to produce a high-efficiency solar panel by reducing the amount of inactive panel area. A relatively larger beam size (e.g., 1 mm wide) can be used for scribing wider P3 interconnect lines to fabricate semi-transparent modules for use in building integrated photovoltaics (BIPV) applications.

BIPV applications, however, may not yet have a sufficient level of market demand to justify separate dedicated laser-scribing systems. Accordingly, it is desirable to develop laser-scribing systems with a selectable size for a laser beam incident on the workpiece.

### BRIEF SUMMARY

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some aspects and embodiments in a simplified form as a prelude to the more detailed description that is presented later.

Systems in accordance with various aspects and embodiments are disclosed for laser-scribing a workpiece. The disclosed systems are operable to remove material from a workpiece with a selectable size of laser beam incident on a workpiece. The capability to change the beam spot size enables the production of different solar-cell assemblies (e.g., for different applications) on the same equipment. Such a capability may serve to reduce fabrication costs by decreasing associated capital costs and/or by increasing system utilization rates.

Thus, in a first aspect, a system is provided for scribing a workpiece. The system includes a frame, a laser coupled with the frame and operable to generate an output to remove material from at least a portion of the workpiece, a beam expander positioned along a path of the laser output and having a motorized mechanism operable to vary a beam expansion ratio applied to the laser output, and at least one scanning device coupled with the frame and operable to control a position of the laser output, after expansion, on the workpiece. In many embodiments, varying the beam expansion ratio varies a beam size incident on the workpiece. In many embodiments, the incident beam size is variable from approximately 20 um to about 1000 um, and in particular from about 50 um to 200 um in certain embodiments. In many embodiments, the motorized beam expander is disposed along an optical path for the laser output between the laser and the scanning device.

In many embodiments, the system for scribing the workpiece can include one or more additional components. For example, the scribing system can include a translation stage coupled with the frame to support the workpiece and translate the supported workpiece relative to the frame in a longitudinal direction. The at least one scanning device can include a plurality of scanning devices optically coupled with the laser and receiving the laser output via the beam expander. The system can include a lateral translation mechanism operable to translate the at least one scanning device traverse to the longitudinal direction. The system can include an exhaust mechanism operable to collect material removed from the workpiece via the laser output.

In another aspect, a method of scribing a workpiece is provided. The method includes generating a laser output to remove material from at least a portion of the workpiece, varying a beam expansion ratio applied to the laser output, and controlling a position of the laser output, after expansion, on the workpiece.

In another aspect, a system for scribing a workpiece is provided. The system includes a frame, a laser coupled with the frame and operable to generate an output to remove material from at least a portion of the workpiece, at least one scanning device coupled with the frame and operable to control a position of the laser output on the workpiece, and a variable aperture positioned along a path of the laser output between the laser and the scanning device and having a motorized mechanism operable to vary a diameter of the laser output entering the scanning device. The variable-aperture system can be configured and/or have the same functionality as the above-described motorized-aperture system.

For a fuller understanding of the nature and advantages of the present invention, reference should be made to the ensuing detailed description and the accompanying drawings. Other aspects, objects and advantages of the invention will be apparent from the drawings and the detailed description that follows.

### BRIEF DESCRIPTION OF THE DRAWINGS

FIG. 1 is a schematic illustration of a scribed assembly used in a thin-film solar cell.

FIG. 2 illustrates a perspective view of a laser-scribing system, in accordance with many embodiments.

FIG. 3 illustrates a side view of a laser-scribing system, in accordance with many embodiments.

FIG. 4 illustrates a set of laser assemblies, in accordance with many embodiments.

FIG. 5 illustrates components of a laser assembly, in accordance with many embodiments.

FIG. 6 illustrates the use of a motorized beam expander to vary a beam size incident on a workpiece, in accordance with many embodiments.

FIG. 7 illustrates the use of a motorized variable aperture to vary a beam size incident on a workpiece, in accordance with many embodiments.

FIG. 8 illustrates a method for scribing a workpiece, in accordance with many embodiments.

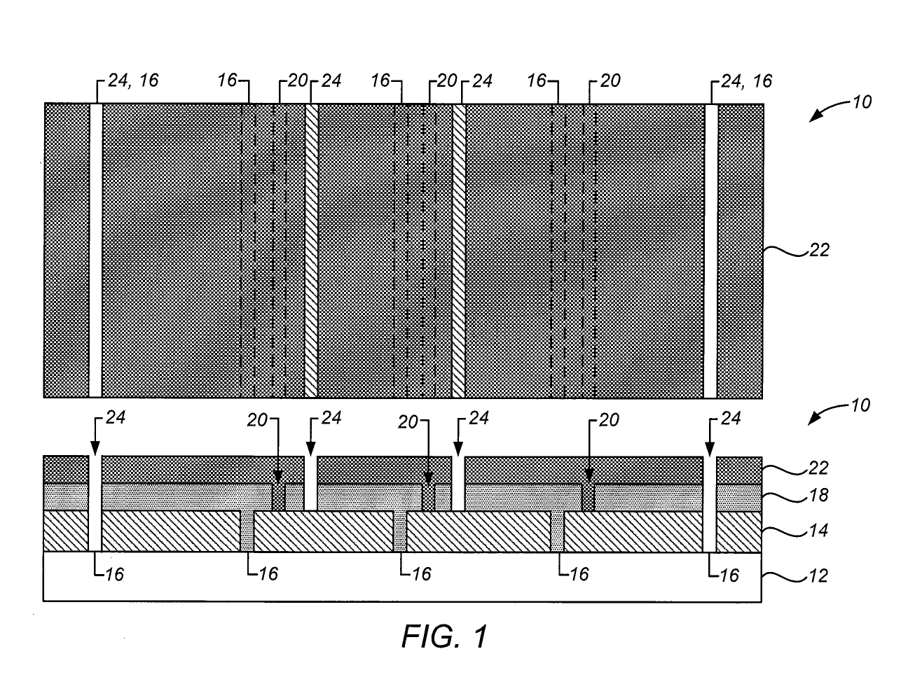

### DETAILED DESCRIPTION

In accordance with various aspects and embodiments of the present disclosure, systems are provided for scribing or otherwise patterning a workpiece with a selectable size of laser output incident on the workpiece. Such scribing systems can be used to scribe multiple line types into the workpiece (e.g., P1 interconnect lines, P1 isolation lines, P2 interconnect lines, P3 interconnect lines, P3 isolation lines). The ability to select the size of laser output incident on the workpiece enables the scribing of solar panel assemblies for different applications, for example, efficiency optimized thin-film solar assemblies and building integrated photovoltaic (BIPV) solar assemblies.

### Laser-Scribing Systems

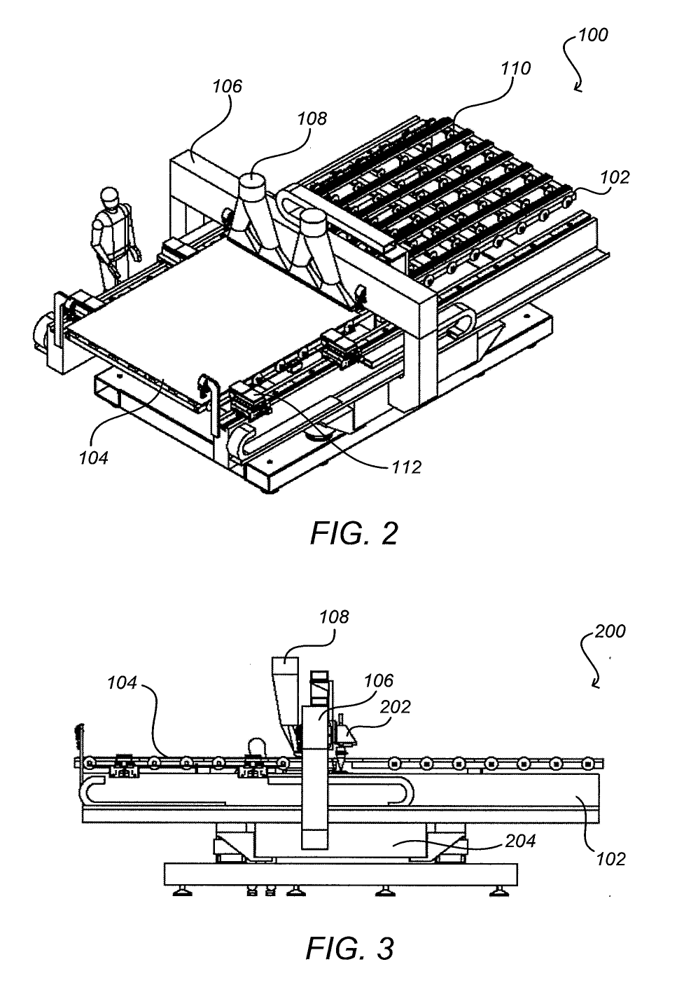

FIG. 2 illustrates an example of a laser-scribing system 100 that can be used in accordance with many embodiments. The scribing system includes a bed or stage 102, which may be level, for receiving and maneuvering a workpiece 104, such as a substrate having at least one layer deposited thereon. In one example, a workpiece is able to move along a single directional vector (i.e., for a Y-stage) at a rate of up to about 2 m/s or more. In many embodiments, the workpiece will be aligned to a fixed orientation with the long axis of the workpiece substantially parallel to the motion of the workpiece in the scribing system. The alignment can be aided by the use of cameras or imaging devices that acquire marks on the workpiece. In this example, the lasers (shown in subsequent figures) are positioned beneath the workpiece and opposite an exhaust arm 106 holding part of an exhaust mechanism 108 for extracting material ablated or otherwise removed from the substrate during the scribing process. The workpiece 104 can be loaded onto a first end of the stage 102 with the substrate side down (towards the lasers) and the layered side up (towards the exhaust). The workpiece is received onto an array of rollers 110 and/or bearings, although other bearing- or translation-type objects can be used to receive and translate the workpiece as known in the art. In this example, the array of rollers all point in a single direction, along the direction of propagation of the substrate, such that the workpiece 104 can be moved back and forth in a longitudinal direction relative to the laser assemblies. The scribing system can include at least one controllable drive mechanism 112 for controlling a direction and translation velocity of the workpiece 104 on the stage 102.

This movement is also illustrated in the side view 200 of FIG. 3, where the substrate moves back and forth along a vector that lies in the plane of the figure. Reference numbers are carried over between figures for somewhat similar elements for purposes of simplicity and explanation, but it should be understood that this should not be interpreted as a limitation on the various embodiments. As the substrate is translated back and forth on the stage 102, a scribing area of the laser assembly effectively scribes from near an edge region of the substrate to near an opposite edge region of the substrate. In order to ensure that the scribe lines are being formed properly, an imaging device can image at least one of the lines after scribing. Further, a beam profiling device 202 can be used to calibrate the beams between processing of substrates or at other appropriate times. In many embodiments where scanners are used, for example, which drift over time, a beam profiler allows for the calibrating of the beam and/or adjustment of beam position. The stage 102, exhaust arm 106, and a base portion 204 can be made out of at least one appropriate material, such as a base portion of granite.

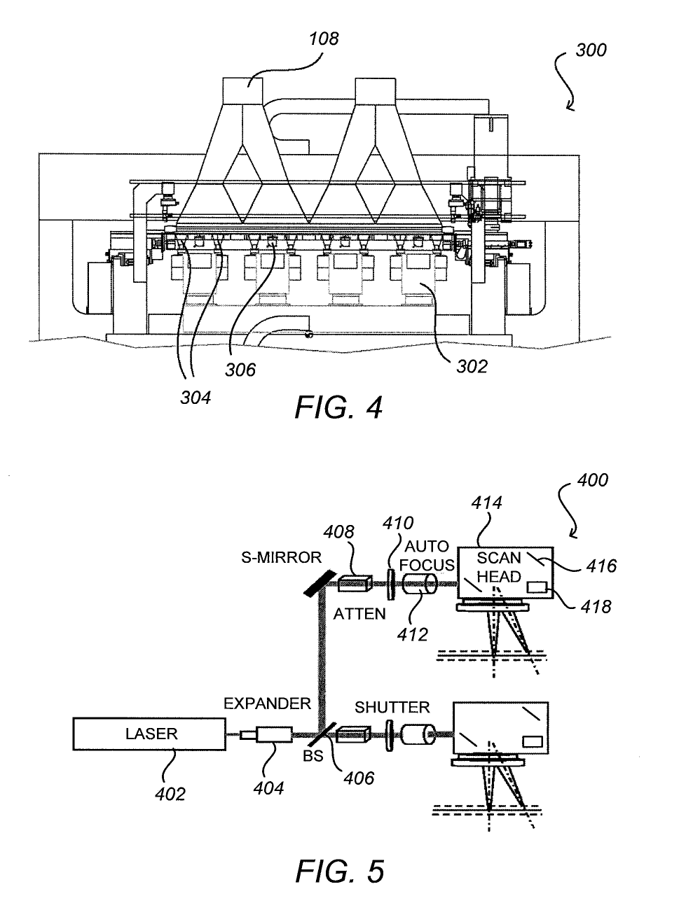

FIG. 4 illustrates an end view 300 of the example scribing system, illustrating a series of laser assemblies 302 used to scribe the layers of the workpiece. In this example, there are four laser assemblies 302, each including a laser device and elements, such as lenses and other optical elements, needed to focus or otherwise adjust aspects of the laser. The laser device can be any appropriate laser device operable to ablate or otherwise scribe at least one layer of the workpiece, such as a pulsed solid-state laser. As can be seen, a portion of the exhaust 108 is positioned opposite each laser assembly relative to the workpiece, in order to effectively exhaust material that is ablated or otherwise removed from the workpiece via the respective laser device. In many embodiments, the system is a split-axis system, where the stage translates the sample along a longitudinal axis. The lasers then can be attached to a translation mechanism able to laterally translate the lasers 302 relative to the workpiece 104. For example, the lasers can be mounted on a support that is able to translate on a lateral rail as driven by a controller and servo motor. In many embodiments, the lasers and laser optics all move together laterally on the support. As discussed below, this allows shifting scan areas laterally and provides other advantages.

In this example, each laser device actually produces two effective beams 304 useful for scribing the workpiece. As can be seen, each portion of the exhaust 108 covers a scan field, or an active area, of the pair of beams in this example, although the exhaust could be further broken down to have a separate portion for the scan field of each individual beam. The figure also shows substrate thickness sensors 306 useful in adjusting heights in the system to maintain proper separation from the substrate due to variations between substrates and/or in a single substrate. Each laser can be adjustable in height (e.g., along the z-axis) using a z-stage, motor, and controller, for example. In many embodiments, the system is able to handle 3-5 mm differences in substrate thickness, although many other such adjustments are possible. The z-motors also can be used to adjust the focus of each laser on the substrate by adjusting the vertical position of the laser itself.

In order to provide the pair of beams, each laser assembly includes at least one beam splitting device. FIG. 5 illustrates basic elements of an example laser assembly 400 that can be used in accordance with many embodiments, although it should be understood that additional or other elements can be used as appropriate. In this assembly 400, a single laser device 402 generates a beam that is expanded using a beam expander 404 then passed to a beam splitter 406, such as a partially transmissive mirror, half-silvered mirror, prism assembly, etc., to form first and second beam portions. In this assembly, each beam portion passes through an attenuating element 408 to attenuate the beam portion, adjusting an intensity or strength of the pulses in that portion, and a shutter 410 to control the shape of each pulse of the beam portion. Each beam portion then also passes through an auto-focusing element 412 to focus the beam portion onto a scan head 414. Each scan head 414 includes at least one element capable of adjusting a position of the beam, such as a galvanometer scanner useful as a directional deflection mechanism. In many embodiments, this is a rotatable mirror able to adjust the position of the beam along a lateral direction, orthogonal to the movement vector of the workpiece, which can allow for adjustment in the position of the beam relative to the intended scribe position. The scan heads then direct each beam concurrently to a respective location on the workpiece. A scan head also can provide for a short distance between the apparatus controlling the position for the laser and the workpiece. Therefore, accuracy and precision is improved. Accordingly, the scribe lines may be formed more precisely (i.e., a scribe 1 line can be closer to a scribe 2 line) such that the efficiency of a completed solar module is improved over that of existing techniques.

In many embodiments, each scan head 414 includes a pair of rotatable mirrors 416, or at least one element capable of adjusting a position of the laser beam in two dimensions (2D). Each scan head includes at least one drive element 418 operable to receive a control signal to adjust a position of the “spot” of the beam within the scan field and relative to the workpiece. In one example, a spot size on the workpiece is on the order of tens of microns within a scan field of approximately 60 mm×60 mm, although various other dimensions are possible. While such an approach allows for improved correction of beam position on the workpiece, it can also allow for the creation of patterns or other non-linear scribe features on the workpiece. Further, the ability to scan the beam in two dimensions means that any pattern can be formed on the workpiece via scribing without having to rotate the workpiece.

### Beam Expander

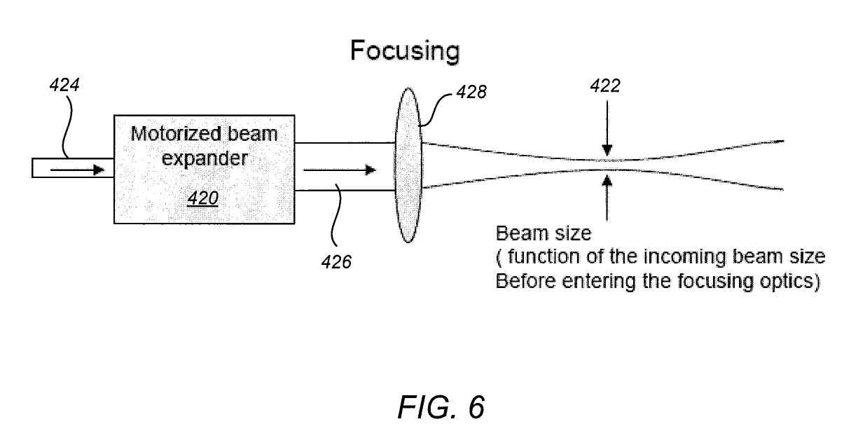

FIG. 6 illustrates the use of a beam expander 420 to vary the size of a beam 422 incident on a workpiece. In this example, the beam expander is a motorized beam expander 420 operable to vary the degree to which an incoming laser beam 424 is expanded, thereby outputting an expanded laser beam 426 to at least one focusing optical element 428. By selectively varying the degree of expansion of the incoming laser beam 424, incident on the optical element, the size of the focused beam 422, near a focus point determined by the selection of the optical element(s), can be selected and controlled. Such a motorized beam expander 420 can be incorporated into the above-described laser-scribing systems, for example, in place of the beam expander 404 (shown in FIG. 5).

The relationship between diameter of the beam (D) going into the scanner/telecentric lens (having focal length f) and the focused spot diameter(s) is given by the theoretical relationship: s=kλfM2/D; where k is a constant for the scanner, λ is the wavelength of the beam and M2 characterizes the Gaussian beam. Therefore, the focused spot size is inversely proportional to the incoming beam diameter (D). As such, to get a larger spot size, a smaller incoming beam is required. Thus, when the tool is needed for processing interconnect lines, a larger beam expanding ratio is used to reduce the spot size at the focus point. For example, with a scanner/telecentric lens having a focal length of 100 mm, a 2× beam expander can output a 2 mm collimated beam to produce a 50 um focused spot. When the tool is needed to process BIPV, a smaller beam expanding ratio is used to enlarge the spot size at the focus point. For example, a 0.5× beam expander can output a 0.5 mm collimated beam to produce a 200 um focused spot using the same scanner/telecentric lens (f=100 mm).

Existing motorized beam expanders can be used. For example, a Special Optics (A Navitar Company, 315 Richard Mine Road, Wharton, N.J. 07885) motorized beam expander (e.g., model 56C-30-2-8X @λ) can be used.

### Variable Aperture

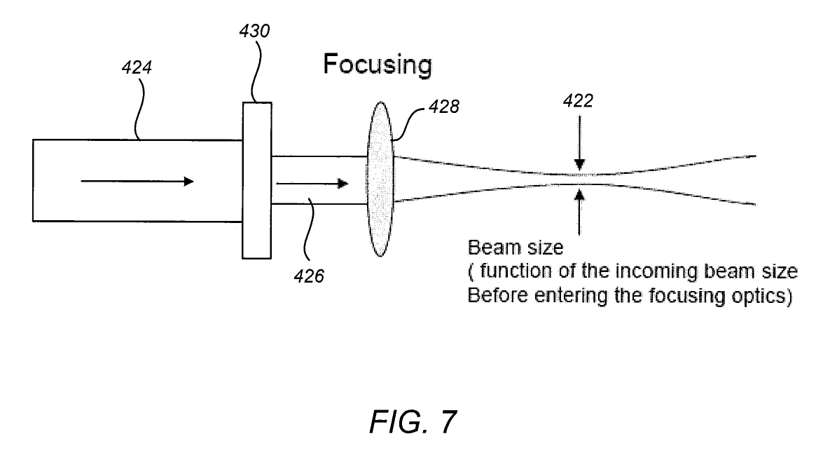

Alternatively, a variable aperture can be used to control the size of the beam going into the lens. FIG. 7 illustrates the use of a variable aperture 430 to control the size of the output laser beam 426 supplied to the at least one focusing optical element 428. The variable aperture 430 selectively limits the incoming laser beam 424 to produce the output laser beam 426. In many embodiments, the variable aperture 430 is motorized to allow for non-manual adjustment of the aperture.

The optimal beam size incident on the workpiece can depend upon factors such as the intended use of the resulting thin-film solar cell. For example, a high precision and small spot size can be used for interconnect line scribing in order to produce a high-efficiency solar panel by reducing the amount of inactive panel area. In building integrated photovoltaic (BIPV) applications, a relatively larger beam size (e.g., 1 mm wide) can be used for scribing wider P3 interconnect lines to fabricate semi-transparent modules that can be used to replace a number of architectural elements commonly made with glass or similar materials, such as windows and skylights.

A laser-scribing system with the capability to change the beam spot size enables the production of different solar-cell assemblies (e.g., for different applications) on the same equipment. Such a capability may serve to reduce fabrication costs by decreasing associated capital costs and/or increasing system utilization rates.

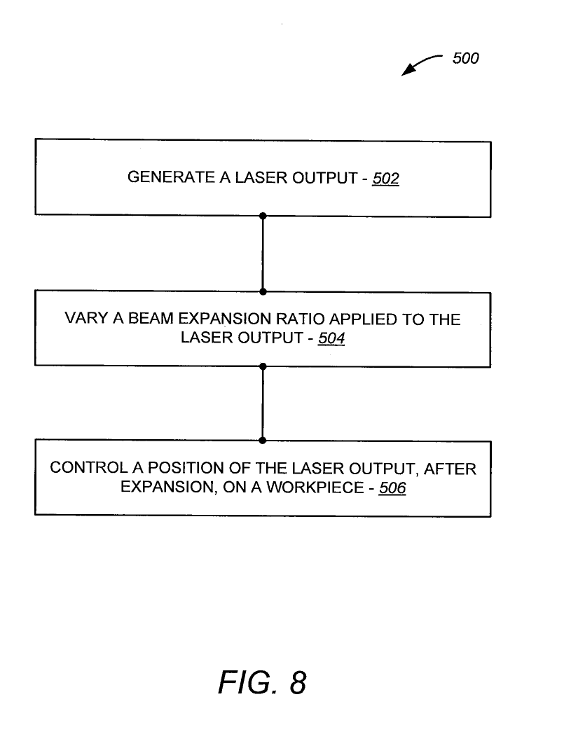

FIG. 8 illustrates a method 500 for scribing a workpiece. In step 502 a laser output is generated. The generated laser output can include one or more laser pulses capable of removing material from a workpiece, such as a glass substrate having a number of layers used in the fabrication of thin-film solar cells. In step 504, a beam expansion ratio applied to the laser output is varied. The beam expansion ratio can be varied in various ways (e.g., with a motorized beam expander, via a motorized aperture). For example, a first beam expansion ratio can be used to scribe a first type of line on a first workpiece. The beam expansion ratio can then be varied so that a second beam expansion ratio is used to scribe a second type of line on the first or a second workpiece. In step 506, a position of the laser output on a workpiece, after expansion, is controlled, for example, by using a scanning device operable to control the position of the laser output on the workpiece in one or more dimensions.

It is understood that the examples and embodiments described herein are for illustrative purposes and that various modifications or changes in light thereof will be suggested to a person skilled in the art and are to be included within the spirit and purview of this application and the scope of the appended claims. Numerous different combinations are possible, and such combinations are considered to be part of the present invention.

What is claimed is:

1. A system for scribing a workpiece, the system comprising:
a frame;
a laser coupled with the frame and operable to generate an output to remove material from at least a portion of the workpiece;
a beam expander positioned along a path of the laser output and having a motorized mechanism operable to vary a beam expansion ratio applied to the laser output; and
at least one scanning device coupled with the frame and operable to control a position of the laser output, after expansion, on the workpiece.

2. The system of claim 1, wherein varying the beam expansion ratio varies a beam size incident on the workpiece.

3. The system of claim 2, wherein the incident beam size is variable from 20 um to 1000 um.

4. The system of claim 3, wherein the incident beam size is variable from 50 um to 200 um.

5. The system of claim 2, wherein the beam expander is disposed along an optical path for the laser output between the laser and the scanning device.

6. The system of claim 1, further comprising a translation stage coupled with the frame to support the workpiece and translate the supported workpiece relative to the frame in a longitudinal direction.

7. The system of claim 1, wherein the at least one scanning device comprises a plurality of scanning devices optically coupled with the laser and receiving the laser output via the beam expander.

8. The system of claim 1, further comprising a lateral translation mechanism operable to translate the at least one scanning device traverse to the longitudinal direction.

9. The system of claim 1, further comprising an exhaust mechanism operable to collect material removed from the workpiece via the laser output.

10. A method of scribing a workpiece, the method comprising:
generating a laser output to remove material from at least a portion of the workpiece;
varying a beam expansion ratio applied to the laser output; and
controlling a position of the laser output, after expansion, on the workpiece.

11. A system for scribing a workpiece, the system comprising:
a frame;
a laser coupled with the frame and operable to generate an output to remove material from at least a portion of the workpiece;
at least one scanning device coupled with the frame and operable to control a position of the laser output on the workpiece; and
a variable aperture positioned along a path of the laser output between the laser and the scanning device and having a motorized mechanism operable to vary a diameter of the laser output entering the scanning device.

12. The system of claim 11, wherein varying a diameter of the laser output entering the scanning device varies a beam size incident on the workpiece.

13. The system of claim 12, wherein the incident beam size is variable from 20 um to 1000 um.

14. The system of claim 13, wherein the incident beam size is variable from 50 um to 200 um.

15. The system of claim 11, further comprising a translation stage coupled with the frame to support the workpiece and translate the supported workpiece relative to the frame in a longitudinal direction.

16. The system of claim 11, wherein the at least one scanning device comprises a plurality of scanning devices optically coupled with the laser and receiving the laser output via the variable aperture.

17. The system of claim 11, further comprising a lateral translation mechanism operable to translate the at least one scanning device traverse to the longitudinal direction.

18. The system of claim 11, further comprising an exhaust mechanism operable to collect material removed from the workpiece via the laser output.
